(19) United States
(12) Patent Application Publication
(10) Pub. No.: US 2009/0116506 A1
(43) Pub. Date: May 7, 2009

(54) METHOD COMMUNICATION ARRANGEMENT AND COMMUNICATION DEVICE FOR ESTABLISHING A COMMUNICATION RELATIONSHIP

(75) Inventors: Stefan Schaefer, Kelkheim (DE); Uwe Schmidtke, Greifswald (DE); Katrin Voigt, Greifswald (DE)

Correspondence Address: K&L Gates LLP, P.O. BOX 1135, CHICAGO, IL, 60690, US

(73) Assignee: Nokia Siemens Networks GmbH & Co., Munchen (DE)

(21) Appl. No.: 11/994,802

(22) PCT Filed: Jun. 26, 2006
(86) PCT No.: PCT/EP2006/063670

§ 371 Date: Jul. 16, 2008

(30) Foreign Application Priority Data
Jul. 4, 2005 (DE) 102005031168.7

(51) Int. Cl. H04L 12/28

(52) U.S. Cl. 370/431

(57) ABSTRACT

According to the invention, connection information (vcxIndex) representing each connection (AE1 . . . n) of the at least one communication device (KE1 . . . n) to a multiplexer device (MUX) is stored in the multiplexer device, the connection information (vcxIndex) is allocated to the at least one communication network specific address (IP) of the at least one communication device (KE1 . . . n) connected to the connector (AE1 . . . n). A message (ARP-REQUEST) sent to the multiplexer device (MUX) is detected and at least one target address (ZA) contained therein is compared with the stored communication network specific addresses (IP). On determination of an at least partial match of the compared pieces of information (IP, ZA) the message (ARP-REQUEST) or information or initiating the communication relationship device is forwarded to the at least one connector (AE1 . . . n) represented by the allocated connector information (vcxIndex). Advantageously, the range of the information broadcast over the communication network or the message receipt is reduced and the data security increased so that the broadcast information or messages can not be received by all users.

### CLAIM FOR PRIORITY

This application is a national stage application of PCT/EP2006/063670, filed Jun. 29, 2006, which claims the benefit of priority to German Application No. 10 2005 031 168.7, filed Jul. 4, 2005, the contents of which hereby incorporated by reference.

### TECHNICAL FIELD OF THE INVENTION

The invention relates to a system and method for setting up a communication relationship.

### BACKGROUND OF THE INVENTION

In current communication networks, particularly subscriber access networks—also called access networks—a plurality of subscribers or communication devices associated with the subscribers are connected to a superordinate communication network or backbone via multiplexer devices—also called DSLAM or Digital Subscriber Line Access Multiplexer. It is the task of the multiplexer devices to forward information from all subscribers to the backbone network and to provide information from the backbone network directly to the individual subscribers. To avoid unnecessary overloading of the capacity of the respective data transmission paths and hence blockage of the connected communication devices, the multiplexer device is designed so that in the upstream direction, i.e. from the individual communication devices to the superordinate communication network, all information to be transmitted is forwarded but in the downstream direction, i.e. from the superordinate communication network to the individual communication devices, only information which is addressed directly to the individual subscribers is forwarded, and only to these subscribers. This means that broadcast information transmitted in the superordinate communication network using broadcast methods is not transmitted from the respective multiplexer device to all respectively connected subscribers or communication devices.

In current communication networks, i.e. both in subscriber access networks (First Mile) and in their connected superordinate communication networks (Second Mile), a level designed on the basis of the Ethernet transmission method or protocol (Layer 2) is frequently implemented (also called Carrier Ethernet communication networks) which is used to provide services designed on the basis of the Internet Protocol (IP), for example. The IP data packets transmitted via such Carrier Ethernet communication networks contain at least one IP address—by contrast the Layer 2 level or Ethernet protocol layer uses Ethernet-specific MAC addresses for pathfinding. To search for the appropriate MAC address for a given IP address, a dedicated procedure has been provided, the Address Resolution Protocol (ARP). By way of example, this protocol needs to be implemented in all IP hosts which are connected to an Ethernet communication network.

In large Carrier Ethernet communication networks with a very large number of subscribers, the data packets or frames in the Address Resolution Protocol (ARP) are a very large data load. ARP frames are broadcast messages, i.e. they are transmitted to the communication network using broadcast methods. In some communication networks, up to 10% of the transmitted information may account just for ARP frames.

In respect of data integrity too, the transmitted ARP frames or messages are a security risk, since all broadcast messages arriving on a multiplexer device, for example, i.e. all ARP frames, are received by all connected subscribers. Disadvantageously, this means that alien MAC or IP addresses for other subscribers can be maliciously adopted for network attacks, for example.

### SUMMARY OF THE INVENTION

The invention discloses minimizing the network load which arises in current communication networks and of improving the information and data integrity within these communication networks.

In one embodiment of the invention, there is a method for setting up a communication relationship with at least one communication device which is connected to at least one communication network via a multiplexer device and which has at least one communication-network-specific address involves at least one message which initiates setup of the communication relationship being transmitted to the multiplexer device.

In one aspect of the invention, connection information respectively representing the connection of the at least one communication device to the multiplexer device is stored in the multiplexer device, where the connection information respectively has the at least one communication-network-specific address of the at least one communication device which is connected to the respective connection associated with it. The at least one message transmitted to the multiplexer device is detected and at least one destination address which the detected message contains is compared with the stored communication-network-specific addresses. If an at least partial match is found for the compared information then the message or piece of information initiating setup of the communication relationship is forwarded to the at least one connection represented by the associated connection information.

One advantage of the invention is that messages transmitted using a broadcast transmission method or broadcast are now transmitted only to the respective relevant subscriber lines or the respective subscribers connected thereto. This reduces the scope of information or volume of messages transmitted via the communication network and increases data integrity, since the broadcast information can no longer be received by all subscribers.

### BRIEF DESCRIPTION OF THE INVENTION

The invention is explained in more detail below with reference to the exemplary Figure, in which:

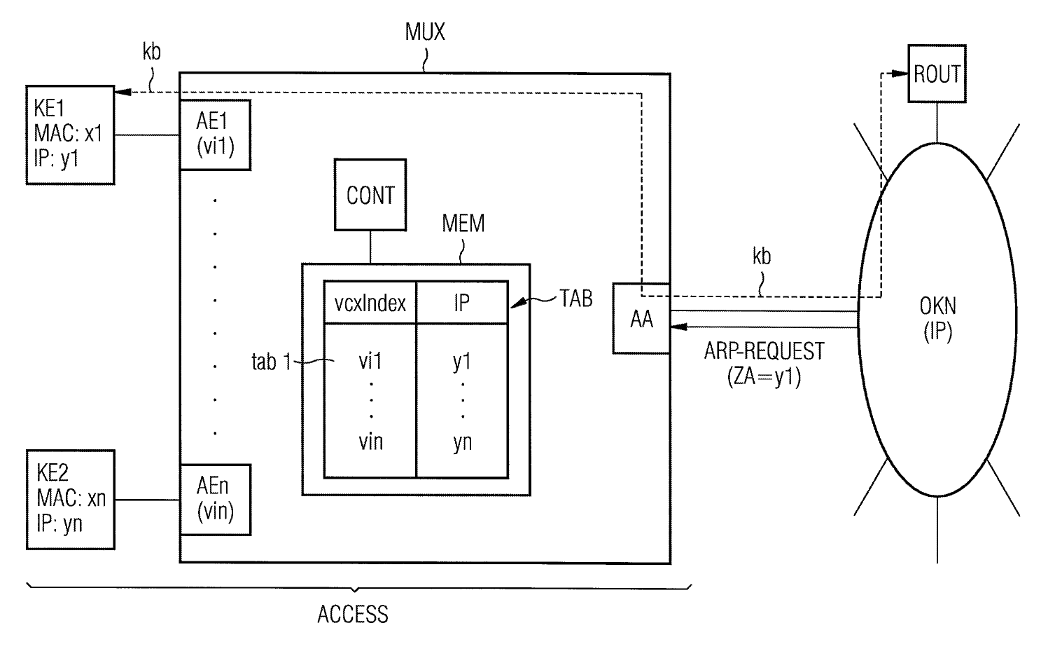

FIG. 1 shows subscribers and/or communication devices which are arranged in a subscriber access network or access network in accordance with an embodiment of the invention.

### DETAILED DESCRIPTION OF THE INVENTION

FIG. 1 shows a plurality of subscribers, or communication devices KE1 . . . n associated with them, which are arranged in a subscriber access network or access network ACCESS and which are connected to appropriate subscriber access units AE1 . . . n in a multiplexer device MUX—also called DSLAM (Digital Subscriber Line Access Multiplexer)—via respective connecting lines. The multiplexer device MUX is connected to a superordinate communication network OKN, designed on the basis of the Internet Protocol, via a further access device AA or uplink. The multiplexer device MUX contains a control apparatus CONT which controls the performance of the inventive method and which has associated memory means MEM. Layer 2 of the subscriber access network ACCESS is designed on the basis of the Ethernet transmission protocol, which is used to provide services designed on the basis of the Internet Protocol IP (e.g. VoIP), for example. The individual communication devices KE1 . . . n have both an Ethernet-compliant address MAC=x1 . . . n (also called MAC (Medium Access Control) address) and an IP address, IP=y1 . . . n, designed on the basis of the Internet Protocol.

In line with the invention, the memory MEM stores a table TAB which has a plurality of table entries tab1 . . . n. Each table entry tab1 . . . n is associated with one of the subscriber access devices AE1 . . . n in the multiplexer device MUX, each of the table entries tab1 . . . n having a piece of information vcxIndex=vi1 . . . n (also called connection index “vcxIndex”) representing the respective connection, i.e. the respective subscriber access device AE1 . . . n. In a further entry or column IP, the respective connection index vcxIndex has the respective IP address IP=y1 . . . n of the at least one communication device KE1 . . . n which is respectively connected to this subscriber access device AE1 . . . n associated with it.

For the rest of the explanation, it will be assumed that a communication device arranged in the superordinate communication network OKN, for example a router ROUT arranged in the communication network OKN, is meant to set up a communication relationship kb with the first communication device KE1—illustrated by a dashed double-headed arrow. To this end, the router ROUT initiates an appropriate internal command, on the basis of which a message initiating the communication relationship to be set up, in this case ARP-REQUEST, is generated and is conveyed to the multiplexer device MUX using broadcast transmission methods. This message ARP-REQUEST includes the IP address of the first communication device KE1, IP=y1, as destination address ZA. In line with the invention, the message ARP-REQUEST arriving on the multiplexer device MUX is detected and the destination address ZA=y1 it includes is recorded. The recorded destination address ZA is compared with the IP addresses y1 . . . n stored in the individual table entries tab1 . . . n. In this exemplary embodiment, the destination address ZA=y1 matches the IP address IP=y1 stored in the first table entry tab. In line with the inventive method, the message ARP-REQUEST received on the multiplexer device MUX is forwarded to the subscriber access device accordingly associated within the table entry tab and represented by the connection index vcxIndex, in this case vcxIndex=vi1=AE1. In line with a first variant embodiment, the message ARP-REQUEST forwarded to the first access device AE1 is forwarded to the first communication device KE1 via the connected connecting line.

Alternatively, the control device CONT arranged in the multiplexer device MUX can generate a command corresponding to the message ARP-REQUEST and can transmit this command or information representing this command to the relevant communication device KE1 via the subscriber access device AE1 represented by the respective connection index vcxIndex.

It will be noted that a subscriber access device AE1 . . . n can have a plurality of communication devices connected to it—not shown—for example via a local area network or LAN. It is fundamental to the invention that messages ARP-REQUEST or appropriate information arriving on the multiplexer device MUX are forwarded via the suitable connection AE1 . . . n. The protocol-compliant further handling of the message forwarded via the connection AE1 . . . n takes place within the local area network.

The response, transmitted under the ARP, from the communication device which is addressed by the destination address ZA and connected to the subscriber access device or subscriber port is then used for the “MAC learning” taking place under the Ethernet protocol in the forwarding database (FDB) and for completion of the ARP table entry and is forwarded to the superordinate communication network OKN. The entry in the FDB and in the ARP table is only erased again if a later ARP-REQUEST is not answered appropriately by the subscriber.

The inventive method now transmits the messages or ARP-REQUESTs transmitted using broadcast methods only to the respective affected, i.e. appropriately addressed, subscribers or communication devices KE1 . . . n. This reduces the volume of messages, and the respective subscribers can only receive the ARP frames which are relevant to them in each case.

Since only the messages or ARP-REQUESTs received from the communication network OKN are used as a trigger for internal messages, there are no timing problems between internal and external processes; this means that the timers arranged in the routers ROUT determine the respective process behavior or the flow of processes.

1. A method for setting up a communication relationship with at least one communication device which is connected to at least one communication network via a multiplexer device (MUX) and which has at least one communication-network-specific address, comprising:
transmitting at least one message initiating setup of the communication relationship via the communication network;
storing connection information respectively representing the connection of the at least one communication device to the multiplexer device in the multiplexer device, where the connection information respectively has the at least one communication-network-specific address of the at least one communication device which is respectively connected to the connection associated with it;
detecting the at least one message transmitted to the multiplexer device and comparing at least one destination address which the detected message contains with the stored communication-network-specific addresses; and
if an at least partial match is found for the compared information, then the message or a piece of information initiating setup of the communication relationship is forwarded to the at least one connection represented by the associated connection information.

2. The method as claimed in claim 1,
wherein
the at least one communication network is a packet-oriented or cell-oriented communication network.

3. The method as claimed in claim 2,
wherein the communication network uses the Internet Protocol, with the at least one communication-network-specific address using the Internet Protocol.

4. The method as claimed in claim 3,
wherein the message initiating the communication relationship uses the Address Resolution Protocol (ARP), with ARP messages transmitted under the Address Resolution Protocol using a broadcast method being detected and destination addresses which the ARP messages include being compared with the communication-network-specific addresses stored in the multiplexer device.

5. A communication arrangement for setting up a communication relationship with at least one communication device which is connected to at least one communication network via a multiplexer device and which has at least one communication-network-specific address, comprising:
a device provided in the communication network for transmitting at least one message initiating setup of the communication relationship;
the multiplexer device has a memory for storing connection information respectively representing the connection of the at least one communication device to the multiplexer device, where the connection information respectively has the at least one communication-network-specific address of the at least one communication device which is respectively connected to the connection associated with it;
a comparator device associated with the multiplexer device is provided to detect the at least one message transmitted to the multiplexer device and compare at least one destination address which the detected message includes with the stored communication-network-specific addresses; and
the comparator device is designed such that if an at least partial match is found for the compared information, then the message or a piece of information initiating setup of the communication relationship is forwarded to the at least one connection represented by the associated connection information.

6. The method as claimed in claim 5,
wherein the at least one communication network is a packet-oriented or cell-oriented communication network.

7. The method as claimed in claim 6,
wherein the communication network uses the Internet Protocol, with the at least one communication-network-specific address using the Internet Protocol.

8. The method as claimed in claim 7,
wherein the message initiating the communication relationship uses the Address Resolution Protocol (ARP),
the comparator device is designed such that ARP messages transmitted under the Address Resolution Protocol using a broadcast method are detected and destination addresses which the ARP messages include are compared with the communication-network-specific addresses stored in the multiplexer device.

9. A communication apparatus for setting up a communication relationship, comprising:
at least one communication device which is configured to be connected to at least one communication network via the communication apparatus and which has at least one communication-network-specific address, wherein
the communication network includes a transmission device for transmitting at least one message initiating setup of the communication relationship to the multiplexer device,
the communication apparatus includes an associated memory for storing connection information respectively representing the connection of the at least one communication device to the communication apparatus, where the connection information respectively has the at least one communication-network-specific address of the at least one communication device which can be respectively connected to the connection associated with it;
a comparator device associated with the communication apparatus is provided to detect the at least one message transmitted to the communication apparatus and to compare at least one destination address which the detected message includes with the stored communication-network-specific addresses, wherein
the comparator device in a form such that if an at least partial match is found for the compared information, then the message or a piece of information initiating setup of the communication relationship is forwarded to the at least one connection represented by the associated connection information.
